(19) United States
(12) Patent Application Publication
(10) Pub. No.: US 2012/0243889 A1
(43) Pub. Date: Sep. 27, 2012

(54) THERMAL SWITCH, MOUNTING STRUCTURE, FIXING DEVICE, AND IMAGE FORMING APPARATUS

(75) Inventors: Katsuya SAITO, Kanagawa (JP); Atsushi HIROI, Kanagawa (JP); Toshihiko MITSUHASHI, Kanagawa (JP)

(73) Assignee: FUJI XEROX CO., LTD., TOKYO (JP)

(21) Appl. No.: 13/280,905

(22) Filed: Oct. 25, 2011

(30) Foreign Application Priority Data
Mar. 25, 2011 (JP) 2011-068748

(51) Int. Cl. G03G 15/20; H01H 37/04

(52) U.S. Cl. 399/33; 337/298

(57) ABSTRACT

A thermal switch includes a body that includes a pair of electrodes and is inserted into an insertion hole formed at a mounting portion so as to be mounted on the mounting portion, a displacement member that is held on the body and displaced according to temperature change, a synchronization member that is provided at the body and separates one contact of the pair of electrodes from the other contact thereof in synchronism with the displacement of the displacement member, and regulating portions that are provided at the body and regulate the separation of the body from the insertion hole.

### CROSS-REFERENCE TO RELATED APPLICATIONS

This application is based on and claims priority under 35 USC 119 from Japanese Patent Application No. 2011-068748 filed Mar. 25, 2011.

### BACKGROUND

1. Technical Field

The present invention relates to a thermal switch, a mounting structure, a fixing device, and an image forming apparatus.

2. SUMMARY

According to an aspect of the invention, there is provided a thermal switch including a body that includes a pair of electrodes and is inserted into an insertion hole formed at a mounting portion so as to be mounted on the mounting portion, a displacement member that is held on the body and displaced according to temperature change, a synchronization member that is provided at the body and separates one contact of the pair of electrodes from the other contact thereof in synchronism with the displacement of the displacement member, and regulating portions that are provided at the body and regulate the separation of the body from the insertion hole.

### BRIEF DESCRIPTION OF THE DRAWINGS

Exemplary embodiments of the present invention will be described in detail based on the following figures, wherein:

FIG. 1 is a schematic view showing the configuration of an image forming apparatus according to this exemplary embodiment;

FIG. 2 is a cross-sectional view showing the configuration of a fixing device according to this exemplary embodiment;

FIG. 3 is a view showing the appearance of a thermostat according to this exemplary embodiment;

FIGS. 4A and 4B are cross-sectional views taken along a line 4-4 of FIG. 3, FIG. 4A shows a thermostat when the temperature of a heating roll (the inside of a housing of the fixing device) is in the range of a predetermined temperature (normal operating temperature), and FIG. 4B shows a thermostat when the temperature of a heating roll (the inside of the housing of the fixing device) exceeds a predetermined temperature (normal operating temperature);

FIG. 5 is a cross-sectional view showing the configuration of the fixing device according to this exemplary embodiment;

FIG. 6 is a schematic view showing a mounting surface, on which a thermostat is mounted, in the fixing device according to this exemplary embodiment;

FIG. 7 is a schematic view showing a mounting structure for mounting a thermostat on the fixing device according to this exemplary embodiment;

FIGS. 8A and 8B are views illustrating a method of forming returning portions of a cap according to this exemplary embodiment;

FIG. 9 is a schematic view showing the configuration of a mounting structure for mounting a thermostat on a fixing device according to a first modification;

FIGS. 10A and 10B are schematic views showing the configuration of a mounting structure for mounting a thermostat on a fixing device according to a second modification; and

FIGS. 11A and 113 are schematic views showing the configuration of a mounting structure for mounting a thermostat on a fixing device according to a third modification.

### DETAILED DESCRIPTION

An example of an exemplary embodiment of the invention will be described below with reference to the drawings.

### Configuration of Image Forming Apparatus According to this Exemplary Embodiment

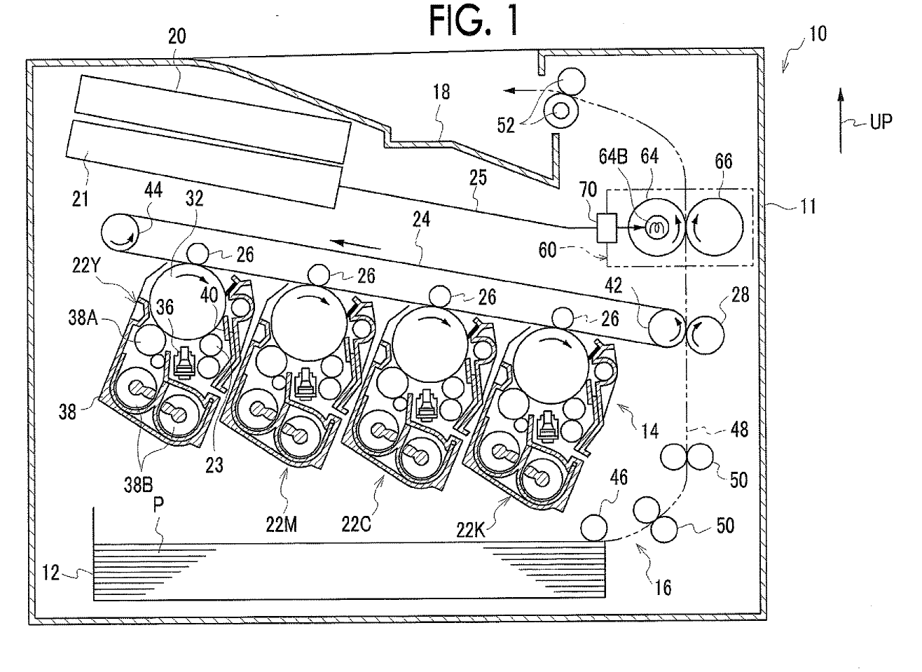

The configuration of an image forming apparatus according to this exemplary embodiment will be described first. FIG. 1 is a schematic view showing the configuration of the image forming apparatus according to this exemplary embodiment. Meanwhile, an arrow UP shown in FIG. 1 represents the upper side in the vertical direction.

As shown in FIG. 1, the image forming apparatus 10 includes an image forming apparatus body 11 in which components are housed. A storage section 12 in which recording media P such as sheets are stored; an image forming section 14 that forms images on a recording medium P; a fixing device 60 that fixes toner images, which are formed on the recording medium P by the image forming section 14, to the recording medium P; a transport section 16 that transports recording media P to the image forming section 14 from the storage section 12; a controller 20 that controls the operations of the respective parts of the image forming apparatus 10; and a power supply section 21 that supplies power to the respective parts of the image forming apparatus 10 are provided in the image forming apparatus body 11. Further, a discharge section 18 to which recording media P on which images have been formed by the image forming section 14 are discharged is provided at the upper portion of the image forming apparatus body 11.

The image forming section 14 includes image forming units 22Y, 22M, 22C, and 22K (hereinafter, referred to as 22Y to 22K) that form color toner images corresponding to yellow (Y), magenta (M), cyan (C), and black (K); an intermediate transfer belt 24 to which the toner images formed by the image forming units 22Y to 22K are transferred; first transfer rolls 26 that transfer the toner images formed by the image forming units 22Y to 22K to the intermediate transfer belt 24; and a second transfer roll 28 that transfers the toner images, which have been transferred to the intermediate transfer belt 24 by the first transfer rolls 26, to a recording medium P from the intermediate transfer belt 24. Meanwhile, the image forming section 14 is not limited to the above-mentioned configuration and may have another configuration as long as images are formed on a recording medium P.

The image forming units 22Y to 22K are disposed side by side at the middle portion of the image forming apparatus 10 in the vertical direction so as to be inclined to the horizontal direction. Further, the image forming units 22Y to 22K include photoreceptors 32 that rotate in one direction (for example, a clockwise direction in FIG. 1), respectively. Meanwhile, since the image forming units 22Y to 22K have the same configuration, the reference numerals of the respective parts of the image forming units 22M, 22C, and 22K are omitted in FIG. 1.

A charging roll 23 as an example of a charging device that charges the photoreceptor 32, an exposure device 36 that forms an electrostatic latent image on the photoreceptor 32 by exposing the photoreceptor 32 charged by the charging roll 23, a developing device 38 that forms a toner image by developing the electrostatic latent image formed on the photoreceptor 32 by the exposure device 36, and a removing member 40 that comes into contact with the photoreceptor 32 and removes a toner remaining on the photoreceptor 32 are provided around each of the photoreceptors 32 in this order from the upstream side in the rotation direction of the photoreceptor 32.

The exposure device 36 forms an electrostatic latent image on the basis of an image signal sent from the controller 20. For example, there is an image signal, which is acquired from an external device by the controller 20, as the image signal sent from the controller 20.

The developing device 38 includes a developer supply body 38A that supplies a developer to the photoreceptor 32 and plural transport members 38B that transport a developer supplied to the developer supply body 38A while agitating the developer.

The intermediate transfer belt 24 is formed in an annular shape, and is disposed above the image forming units 22Y to 22K. Winding rolls 42 and 44 on which the intermediate transfer belt 24 is wound are provided on the inner periphery of the intermediate transfer belt 24. When either the winding roll or the winding roll 44 is rotationally driven, the intermediate transfer belt 24 circularly moves (rotates) in one direction (for example, the counterclockwise direction in FIG. 1) while coming into contact with the photoreceptors 32. Meanwhile, the winding roll 42 is a counter roll that faces the second transfer roll 28.

The first transfer roll 26 faces the photoreceptor 32 with the intermediate transfer belt 24 interposed therebetween. A first transfer position where the toner image formed on the photoreceptor 32 is transferred to the intermediate transfer belt 24 is formed between the first transfer roll 26 and the photoreceptor 32.

The second transfer roll 28 faces the winding roll 42 with the intermediate transfer belt 24 interposed therebetween. A second transfer position where the toner images transferred to the intermediate transfer belt 24 are transferred to a recording medium P is formed between the second transfer roll 28 and the winding roll 42.

The transport section 16 includes a feed roll 46 that feeds a recording medium P stored in the storage section 12, a transport path 48 along which the recording medium P fed by the feed roll 46 is transported, and plural transport rolls 50 that are disposed along the transport path 48 and transport the recording medium P fed by the feed roll 46 to the second transfer position.

The fixing device 60, which fixes the toner images formed on the recording medium P by the image forming section 14 to the recording medium P, is provided on the downstream side of the second transfer position in a transport direction. Discharge rolls 52, which discharge the recording medium P to which the toner images have been fixed to the discharge section 18, are provided on the downstream side of the fixing device in the transport direction. Meanwhile, the specific configuration of the fixing device 60 will be described below.

Next, the image forming operations of the image forming apparatus 10 according to this exemplary embodiment, which form an image on a recording medium P, will be described.

In the image forming apparatus 10 according to this exemplary embodiment, a recording medium P, which is fed from the storage section 12 by the feed roll 46, is fed to the second transfer position by the plural transport rolls 50.

Meanwhile, in each of the image forming units 22Y to 22K, the photoreceptor 32, which is charged by the charging roll 23, is exposed by the exposure device 36, so that an electrostatic latent image is formed on the photoreceptor 32. The electrostatic latent image is developed by the developing device 38, so that a toner image is formed on the photoreceptor 32. The respective color toner images, which are formed by the image forming units 22Y to 22K, are superimposed on the intermediate transfer belt 24 at the first transfer positions, so that a color image is formed. Further, the color image, which is formed on the intermediate transfer belt 24, is transferred to a recording medium P at the second transfer position.

The recording medium P to which the toner images have been transferred is transported to the fixing device 60 and the transferred toner images are fixed by the fixing device 60. The recording medium P to which the toner images have been fixed is discharged to the discharge section 18 by the discharge rolls 52. A series of the image forming operations is performed as described above.

### Configuration of Fixing Device 60 According to this Exemplary Embodiment

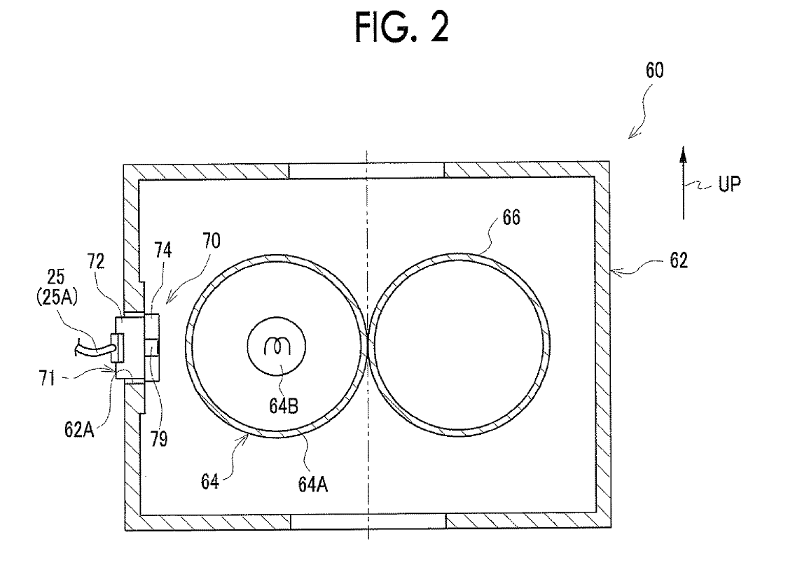

Next, the configuration of the fixing device 60 according to this exemplary embodiment will be described. FIG. 2 is a schematic view showing the configuration of the fixing device 60 according to this exemplary embodiment. Meanwhile, an arrow UP shown in FIG. 2 represents the upper side in the vertical direction.

As shown in FIG. 2, the fixing device 60 according to this exemplary embodiment is detachably mounted on the image forming apparatus body 11 (see FIG. 1), and includes a device housing 62 in which components are provided. A heating roll 64 as an example of a heating member that heats an image formed on a recording medium, and a pressure belt 66 as an example of a pressure member are provided in the device housing 62.

The heating roll 64 includes a cylindrical member 64A and a heating source 64B such as a halogen lamp that is provided in the internal space of the cylindrical member 64A. The cylindrical member 64A is made of a metal material, such as aluminum or stainless steel.

The heating source 64B is electrically connected to the power supply section 21 by an electrical circuit 25 as an example of a circuit that supplies power to the heating roll 64 (heating source 64B). Accordingly, the heating source 64B is adapted so as to be supplied with power from the power supply section 21 through the electrical circuit 25.

The pressure belt 66 rotates with a recording medium P interposed between itself and the heating roll 64, and is formed of an annular transport belt that transports the recording medium P while pressing the recording medium P.

Toners are heated by the heating roll 64 and pressed by the pressure belt 66, so that an image is fixed to the recording medium P, which is transported while being interposed between the heating roll 64 and the pressure belt 66, at the contact area between the heating roll 64 and the pressure belt 66. Meanwhile, in FIG. 2, the transport path along which the recording medium P is transported by the heating roll 64 and the pressure belt 66 is shown by a two-dot chain line.

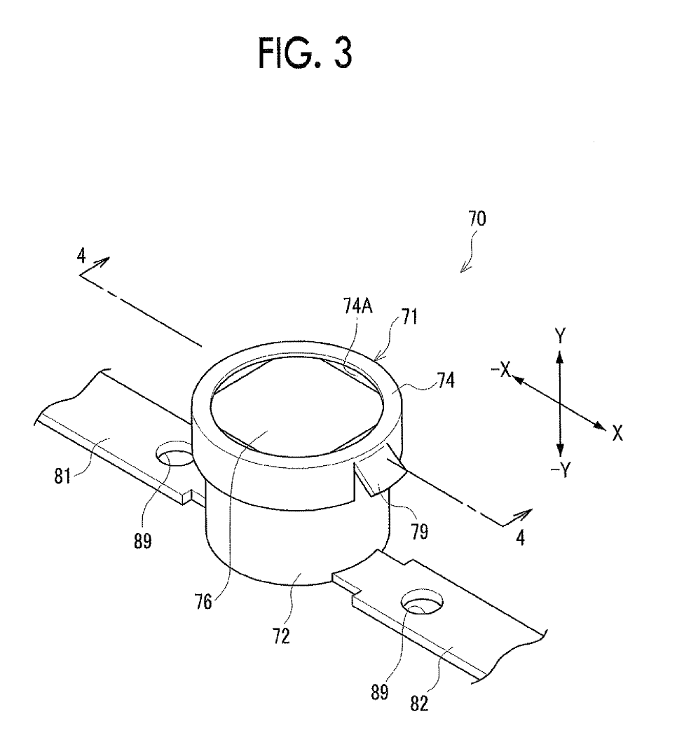

A thermostat 70 as an example of a thermal switch is provided at the device housing 62 of the fixing device 60. Specifically, the thermostat 70 is provided at the device housing 62 of the fixing device 60 so that a bimetal 76 (see FIG. 3) to be described below faces the heating roll 64 with a predetermined gap between the heating roll 64 and the thermostat 70. As shown in FIG. 1, the thermostat 70 is provided in the electrical circuit 25, and is adapted so as to shut off the electrical circuit 25 and stop the supply of power to the heating source 64B from the power supply section 21 when the temperature of the heating roll 64 (the inside of the device housing 62) reaches a predetermined temperature.

### Specific Configuration of Thermostat 70 According to this Exemplary Embodiment

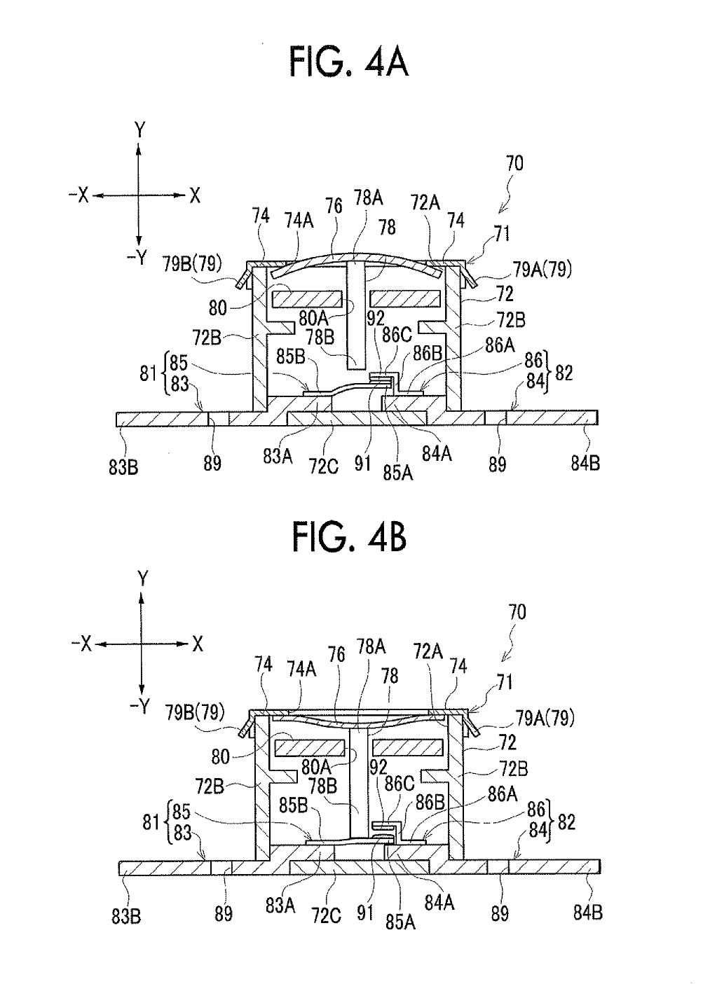

Next, the specific configuration of the thermostat 70 according to this exemplary embodiment will be described. FIGS. 3, 4A, and 4B are schematic views showing the configuration of the thermostat 70. Meanwhile, the X direction, the negative X direction, the Y direction, and the negative Y direction, which will be described below, are the directions of arrows shown in the drawings.

As shown in FIGS. 2 and 3, the thermostat 70 according to this exemplary embodiment includes a body 71 that is mounted on the device housing 62 as an example of a mounting portion of the fixing device 60. Meanwhile, a specific mounting structure for mounting the thermostat 70 on the device housing 62 will be described below.

As shown in FIGS. 4A and 45, the body 71 of the thermostat 70 includes a cylindrical housing 72 that includes an open portion 72A at one end portion thereof (an end portion thereof in the Y direction), a cap 74 as an example of a holding member that is provided at the open portion 72A of the housing 72, and first and second electrodes 81 and 82 as an example of a pair of electrodes that is provided in the housing 72.

The housing 72 is made of a material having an insulating property. For example, ceramics, a phenolic resin, polyphenylene sulfide, and the like may be used as the material having an insulating property. Meanwhile, the shape and material of the housing 72 are not limited to the above-mentioned shape and material.

The bimetal 76 as an example of a displacement member, which is displaced according to the temperature change, is provided at the open portion 72A of the housing 72. The bimetal 76 is formed in the shape of a disc spring (by drawing), and is held on the housing 72 by the cap 74 so as to be concave from the inside of the housing 72 (in a state shown in FIG. 4A). Further, the bimetal 76 is formed by joining two kinds of metal having different coefficients of linear expansion. Accordingly, when the temperature of the bimetal 76 reaches a predetermined temperature, the bimetal 76 is displaced (inverted) so as to be convex toward the inside of the housing 72 (to a state shown in FIG. 4B).

As shown in FIG. 3, a circular opening portion 74A through which the surface of the bimetal 76 is exposed to the outside is formed at the central portion of the cap 74 in plan view (when seen in the negative Y direction). The cap 74 is fixed to the housing 72 by being caulked to the housing 72.

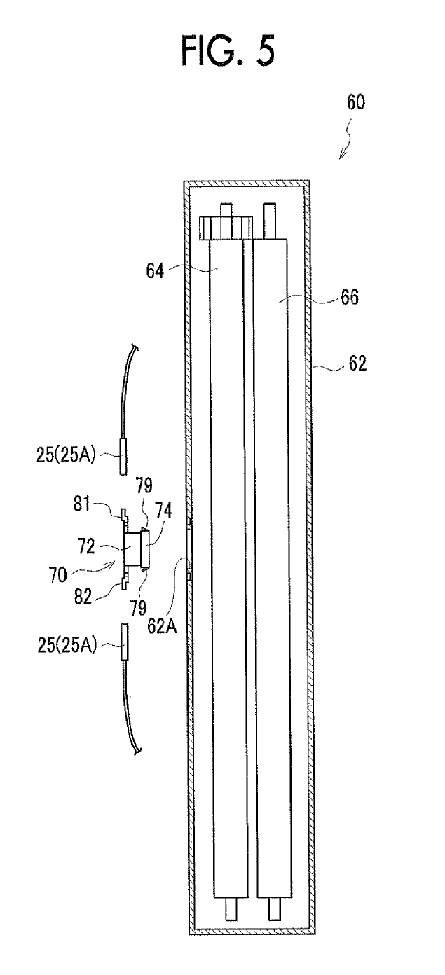

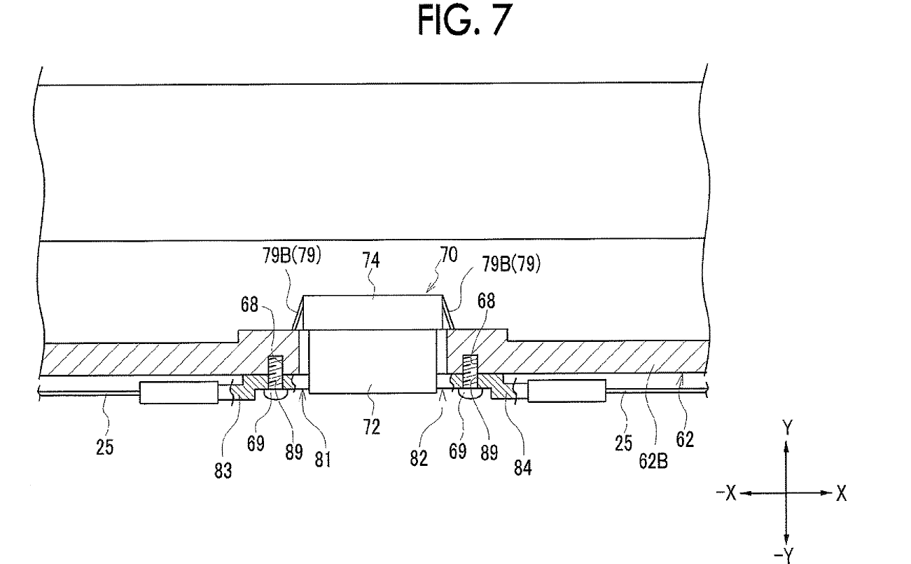

As shown in FIGS. 4A and 4B, the first electrode 81 includes a first connection electrode 83 and a first contact electrode 85. The first connection electrode 83 is led to the outside from the inside of the housing 72 and connected to a conductive wire 25A (see FIGS. 5 and 7) of the electrical circuit 25. The first contact electrode 85 is electrically connected to the first connection electrode 83 in the housing 72 and includes a first contact 91.

The first connection electrode 83 is formed of a plate-like electrode that has a length in the radial direction of the housing 72 (the X direction). One end portion 83A of the first connection electrode 83 in the longitudinal direction (an end portion of the first connection electrode 83 in the X direction) is disposed in the housing 72 on a bottom wall 72C of the housing 72 at the position closer to the outer portion of the bottom wall 72C more in the radial direction than the central portion of the bottom wall 72C in the radial direction. The first connection electrode 83 is bent at the middle portion thereof in the longitudinal direction, and the other end portion 83B of the first connection electrode 83 in the longitudinal direction (an end portion of the first connection electrode 83 in the negative X direction) is led to the outside of a side wall 72B of the housing 72 (in the negative X direction).

The first contact electrode 85 includes the first contact 91 at one end portion 85A thereof (an end portion of the first contact electrode 85 in the X direction), and the other end portion 85B (an end portion in the negative X direction) is fixed to the one end portion 83A of the first connection electrode 83 in the longitudinal direction (the end portion of the first connection electrode 83 in the X direction). The first contact 91 faces the bimetal 76 (the Y direction). While the first contact electrode 85 comes into contact with a second contact 92 to be described below, the first contact 91 is urged toward the bimetal 76 (the Y direction). Specifically, since the first contact electrode 85 is formed of a leaf spring, the first contact electrode 85 is urged toward the bimetal 76 (the Y direction) by its own elastic force.

As shown in FIGS. 4A and 4B, the second electrode 82 includes a second connection electrode 84 and a second contact electrode 86. The second connection electrode 84 is led to the outside from the inside of the housing 72 and connected to the conductive wire 25A (see FIGS. 5 and 7) of the electrical circuit 25. The second contact electrode 86 is electrically connected to the second connection electrode 84 in the housing 72 and includes a second contact 92.

The second connection electrode 84 is formed of a plate-like electrode that has a length in the radial direction of the housing 72 (the X direction). One end portion 84A of the second connection electrode 84 in the longitudinal direction (an end portion of the second connection electrode 84 in the negative X direction) is disposed in the housing 72 on the bottom wall 72C of the housing 72 at the position closer to the outer portion of the bottom wall 72C in the radial direction than the central portion of the bottom wall 72C in the radial direction. The second connection electrode 84 is bent at the middle portion thereof in the longitudinal direction, and the other end portion 84B of the second connection electrode 84 in the longitudinal direction (an end portion of the second connection electrode 84 in the X direction) is led to the outside of the side wall 72B of the housing 72 (in the X direction).

The second contact electrode 86 includes a first portion 86A that is fixed to one end portion 84A of the second connection electrode 84 in the longitudinal direction (an end portion of the second connection electrode 84 in the negative X direction), a second portion 86B that extends toward the bimetal 76 (the Y direction) from an end portion of the first portion 86A in the negative X direction, and a third portion 860 that extends toward the central portion of the housing 72 in the radial direction from an end portion of the second portion 86B in the Y direction.

The second contact electrode 86 includes the second contact 92 at the third portion 86C (an end portion of the second contact electrode 86 in the negative X direction). The second contact 92 faces the first contact 91 (the negative Y direction), and comes into contact with the first contact 91 that is urged toward the bimetal 76 (the Y direction).

Accordingly, a counter force acts toward the side where the first contact 91 of the first contact electrode 85 is separated from the second contact 92 against an urging force (the negative Y direction), so that the first contact 91 is separated from the second contact 92. Therefore, the counter force does not act, so that the first contact 91 comes into contact with the second contact 92.

In addition, the thermostat 70 includes a pin 78 as an example of a synchronization member that is provided between the bimetal 76 and the first electrode 81 (the first contact electrode 85) and separates the first contact 91 from the second contact 92 in synchronism with the displacement of the bimetal 76. The pin 78 has a length in the axial direction of the housing 72 (the direction of an arrow Y in FIGS. 4A and 4B), and is formed in the shape of a rod (for example, a columnar shape). Further, the pin 78 is disposed at the central portion of the housing 72 in plan view (when seen in the negative Y direction), and is not fixed to any member.

One end portion 78A of the pin 78 (an end portion of the pin 78 in the Y direction) functions as a portion that comes into contact with the bimetal 76 displaced so as to be convex toward the inside of the housing 72 (to a state shown in FIG. 4B) and is pushed toward the first contact electrode 85 of the first electrode 81 (the negative Y direction). The other end portion 78B of the pin 78 (an end portion of the pin 78 in the negative Y direction) functions as a portion that pushes the first contact electrode 85 of the first electrode 81 toward the bottom wall 72C of the housing 72 (the negative Y direction) when the one end portion 78A is pushed toward the first contact electrode 85 of the first electrode 81.

Moreover, a pin guide 80, which guides the pin 78 in the axial direction of the housing 72 (the Y direction), is provided in the housing 72. The pin guide 80 is formed in the shape of a disc and is provided with an insertion hole 80A, which is penetrated in the axial direction of the housing 72 (the Y direction) and into which the pin 78 is inserted, therein. While the pin 78 is inserted into the pin guide 80, the pin 78 is allowed to move along the insertion hole 80A of the pin guide 80 in the axial direction of the housing 72 (the Y direction) and comes into contact with the inner wall of the pin guide 80. Accordingly, the movement of the pin 78 in the radial direction of the housing 72 (the negative X direction and the X direction) is regulated in the pin guide 80.

### Specific Mounting Structure for Mounting Thermostat 70 on Device Housing 62 of Fixing Device 60

As shown in FIG. 2 and FIGS. 5 to 7, an insertion hole 62A into which the cap 74 and the housing 72 of the thermostat 70 are inserted is formed at the device housing 62 of the fixing device 60. Accordingly, the diameter of the insertion hole 62A is set to a diameter that is equal to or larger than the outer diameter of the cap 74 and the outer diameter of the housing 72.

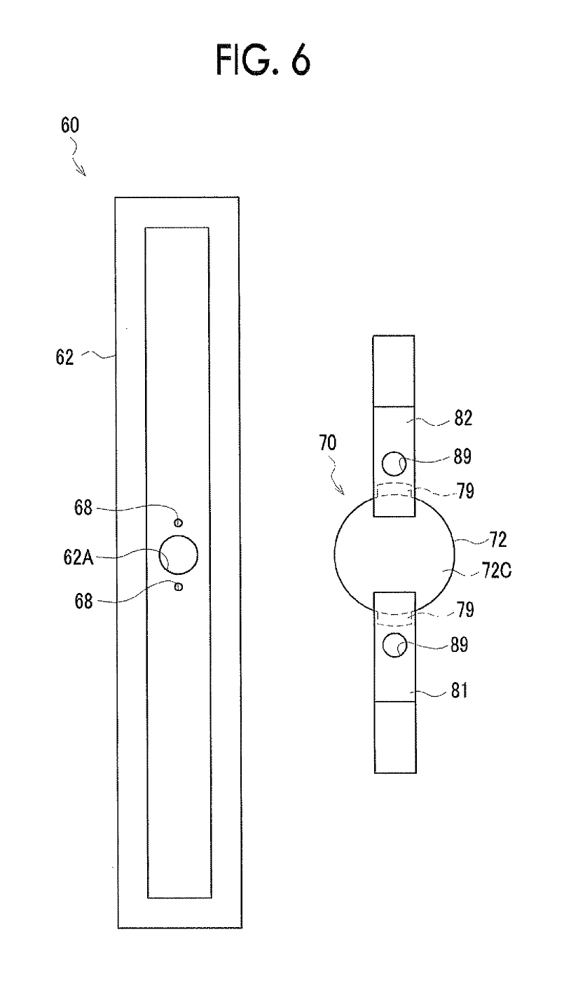

Further, as shown in FIGS. 6 and 7, screw holes 68 as an example of fixing object portions are formed at the device housing 62 of the fixing device 60 on both sides of the insertion hole 62A. Meanwhile, as shown in FIG. 7, a through hole 89 through which a screw 69 as an example of a fixing member fixing the thermostat 70 passes is formed at the second connection electrode 84 of the thermostat 70.

The cap 74 and the housing 72 are inserted into the insertion hole 62A of the fixing device 60 and the screw 69 having passed through the through hole 89 is tightened to the screw hole 68, so that the thermostat 70 is mounted on the device housing 62 of the fixing device 60.

Here, in this exemplary embodiment, returning portions 79 as regulating portions, which regulate the separation of the thermostat 70 from the insertion hole 62A of the fixing device 60, are formed in the cap 74 of the thermostat 70.

The returning portions 79 are formed of two returning portions 79A and 79B that are formed at both sides of the cap with the bimetal 76 interposed therebetween so as to face each other.

The end portions (base end portions) of the returning portions 79A and 79B in the Y direction are connected to the cap 74, and the returning portions 79A and 79B are inclined to the axial direction of the housing 72 (the Y direction) so as to gradually spread out in the radial direction (the X direction in the case of the returning portion 79A and the negative X direction in the case of the returning portion 79B) toward the end portions (leading end portions) of the returning portions 79A and 79B in the negative Y direction.

The returning portions 79A and 79B are formed of leaf springs of which end portions (leading end portions) in the negative Y direction can be closed to the inside in the radial direction (the negative X direction in the case of the returning portion 79A and the X direction in the case of the returning portion 79B). Accordingly, when the thermostat 70 is inserted into the insertion hole 62A of the fixing device 60, the returning portions 79A and 79B come into contact with the inner wall of the insertion hole 62A and are closed. When reaching the inner side of a wall 62B of the device housing 62 (the side of the wall 62B in the Y direction), the returning portions 79A and 79B spread out in the radial direction of the housing 72 by the elastic forces thereof.

In this state, the end portions (leading end portions) of the returning portions 79A and 79B in the negative Y direction are caught by the wall of the device housing 62, so that the separation of the thermostat 70 from the insertion hole 62A is regulated.

Moreover, in this exemplary embodiment, the cap 74 is mounted on the housing 72 so as to be separated from the housing 72 when a predetermined load is applied to the returning portions 79A and 79B in the Y direction.

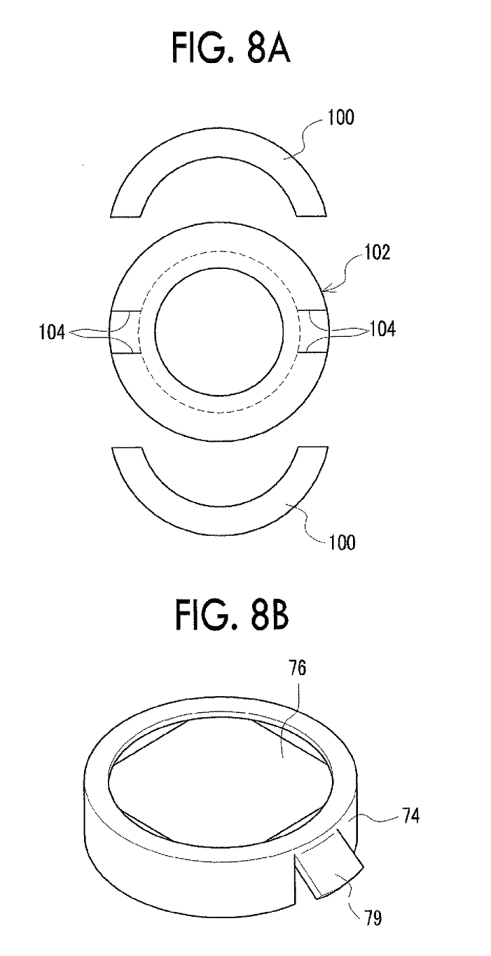

As shown in FIGS. 8A and 8B, the cap 74 including the returning portions 79A and 79B is formed by forming cuts (notches) 104 at two portions, where the returning portions 79 are to be formed, of an annular plate member 102 that is used to form the cap 74 but is not yet formed as the cap 74, and caulking the annular plate member 102 to the housing 72 by the pressing of a pressing machine 100.

### Operation of this Exemplary Embodiment

Next, the operation of this exemplary embodiment will be described.

According to the configuration of this exemplary embodiment, when the temperature of the heating roll 64 (the inside of the device housing 62) is in the range of a predetermined temperature (normal operating temperature), the bimetal 76 is in a concave state where the bimetal 76 is concave from the inside of the housing 72 as shown in FIG. 4A.

In this case, a counter force against the urging force of the first electrode 81 does not act, so that the first contact 91 comes into contact with the second contact 92 of the second electrode 82. Accordingly, the electrical circuit 25 is not shut off and power is supplied to the heating source 64B from the power supply section 21 through the electrical circuit 25.

When the temperature of the heating roll 64 (the inside of the device housing 62) of the fixing device 60 exceeds a predetermined temperature (normal operating temperature) and becomes high, the bimetal 76 is displaced (inverted) so as to be convex toward the inside of the housing 72 as shown in FIG. 4B.

When the bimetal 76 is displaced (inverted) so as to be convex toward the inside of the housing 72, one end portion 78A of the pin 78 (an end portion of the pin 78 in the Y direction) is pushed toward the first contact electrode 85 (the negative Y direction) by the bimetal 76. Accordingly, the pin 78 moves toward the first contact electrode 85. Therefore, the other end portion 78B of the pin 78 (an end portion of the pin 78 in the negative Y direction) pushes the first contact electrode 85 toward the bottom wall 72C of the housing 72 (the negative Y direction) against the urging force of the first contact electrode 85. Accordingly, the first contact 91 of the first contact electrode 85 moves toward the bottom wall 72C, so that the first and second contacts 91 and 92 are separated from each other. Therefore, the electrical circuit 25 is shut off and the supply of power to the heating source 64B from the power supply section 21 is stopped.

Here, even when the thermostat 70 is to be separated from the device housing 62 of the fixing device 60 to perform an inappropriate action (abnormal repair) for mechanically returning the bimetal 76, which has been inverted as described above, by force, the returning portions 79A and 79B are caught by the wall of the device housing 62. Accordingly, the thermostat 70 is not separated from the device housing 62 of the fixing device 60. Therefore, an inappropriate action, which is performed after the thermostat 70 is operated and separated from the device housing 62, is suppressed.

In addition, when the thermostat 70 is forcibly separated from the insertion hole 62A to separate the thermostat 70 from the device housing 62 of the fixing device 60, the cap 74 is separated from the housing 72. When the cap 74 is separated from the housing 72, the bimetal 76 held by the cap 74 is separated from the housing 72. Accordingly, the thermostat 70 cannot be reused.

### First Modification

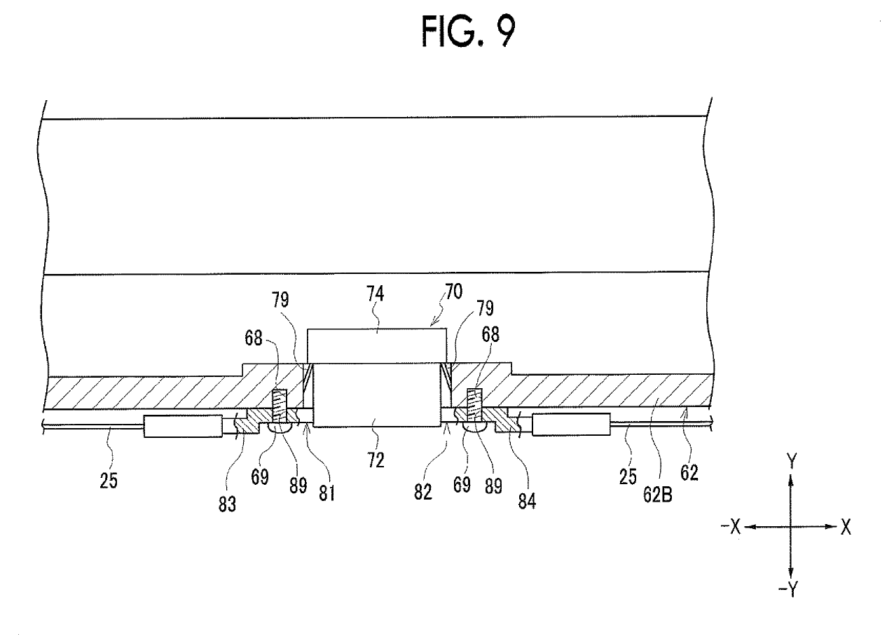

In the above-mentioned exemplary embodiment, the returning portions 79 are formed at the thermostat 70. However, in a first modification, returning portions 79 are formed at a device housing 62 of a fixing device 60 as shown in FIG. 9. Even in this configuration, leading end portions of the returning portions 79 come into contact with a cap 74 and the cap 74 is mounted on a housing 72 so as to be separated from the housing 72 when a predetermined load is applied to the returning portions 79 in the negative Y direction.

Accordingly, when the thermostat 70 is forcibly separated from the insertion hole 62A to separate the thermostat 70 from the device housing 62 of the fixing device 60, the cap 74 is separated from the housing 72. When the cap 74 is separated from the housing 72, the bimetal 76 held by the cap 74 is separated from the housing 72. Accordingly, the thermostat 70 cannot be reused.

### Second Modification

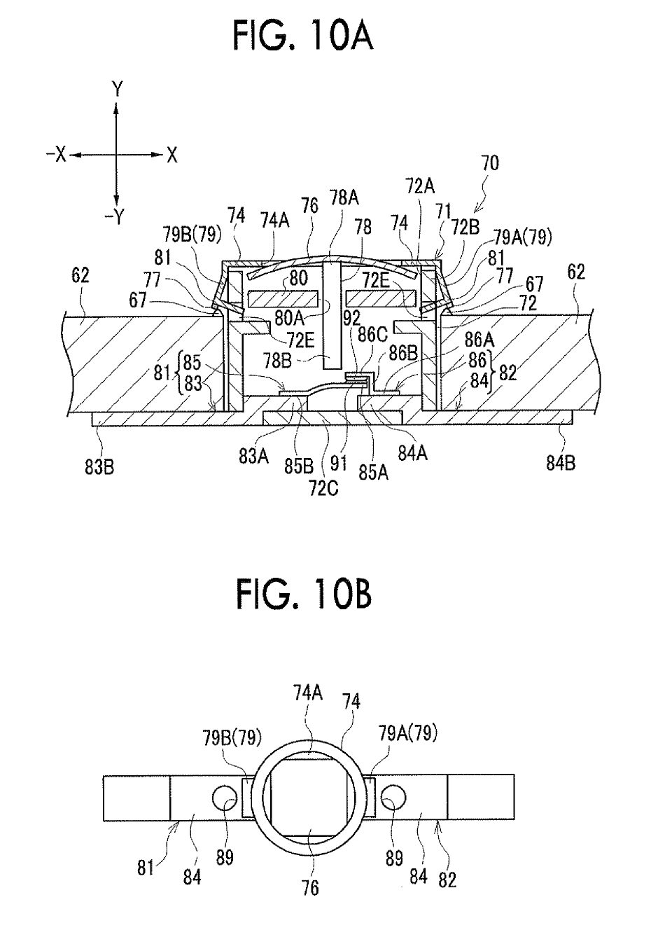

Moreover, there is a configuration according to a second modification shown in FIGS. 10A and 10B as a configuration where a cap 74 is separated from a housing 72 when a predetermined load is applied to returning portions 79. In the configuration according to the second modification, insertion holes 72E into which returning portions 79A and 79B are inserted are formed at a side wall 72B of a housing 72.

The returning portions 79A and 79B are bent at longitudinal middle portions 81, which protrude from the cap 74 in the negative Y direction, toward the inside in the radial direction of the housing 72 (the negative X direction in the case of the returning portion 79A and the X direction in the case of the returning portion 79B).

The side wall 7213 is interposed between the cap 74, which is disposed at the end portion of the side wall 72B of the housing 72 corresponding to a bimetal 76 (an end portion of the side wall 72B in the Y direction), and the end portions of the returning portions 79A and 79B in the negative Y direction (the leading end portions of the returning portions 79A and 79B). Accordingly, the cap 74 is held on the housing 72.

Protrusions 77, which protrude toward a device housing 62 of the fixing device 60 (the negative Y direction), are formed at the longitudinal middle portions (bent portions) 81 of the returning portions 79A and 79B. Protrusions 67, which come into contact with the protrusions 77 on the inside in the radial direction of the housing 72 (the negative X direction in the case of the returning portion 79A and the X direction in the case of the returning portion 79B), are formed at the device housing 62.

In this configuration, when the thermostat 70 is forcibly separated from the insertion hole 62A to separate the thermostat 70 from the device housing 62 of the fixing device 60, the protrusions 67 of the device housing 62 come into contact with the protrusions 77 of the returning portions 79A and 79B and the returning portions 79A and 79B are pushed to the outside in the radial direction of the housing 72 (the X direction in the case of the returning portion 79A and the negative X direction in the case of the returning portion 79B). Accordingly, the end portions of the returning portions 79A and 79B in the negative Y direction (the leading end portions of the returning portions 79A and 79B) are separated from the insertion holes 72E, so that the cap 74 is separated from the housing 72. When the cap 74 is separated from the housing 72, the bimetal 76 held by the cap 74 is separated from the housing 72. Accordingly, the thermostat 70 cannot be reused.

### Third Modification

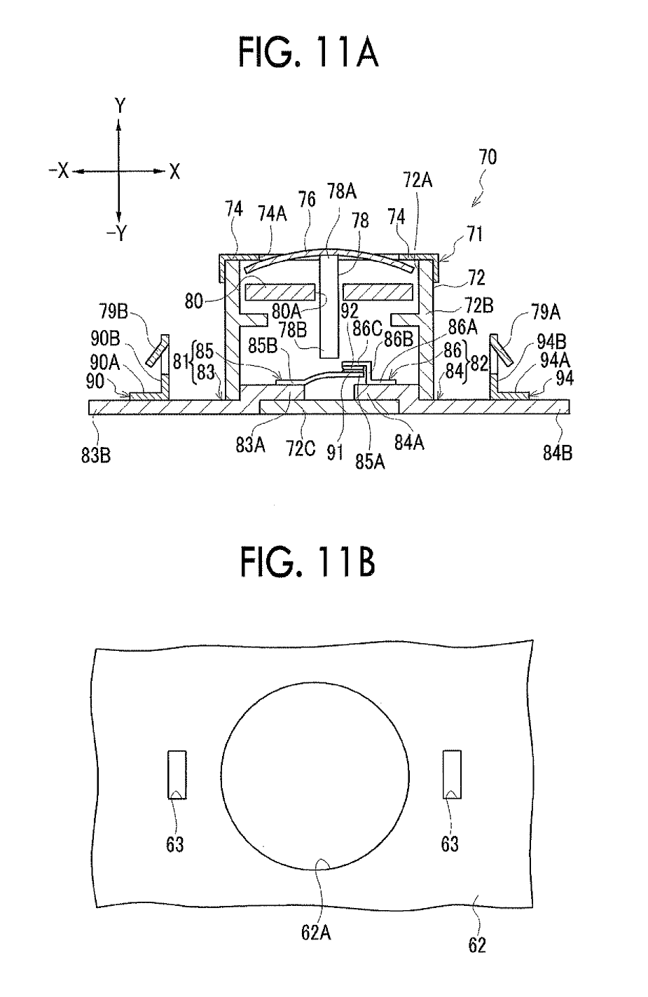

In the above-mentioned exemplary embodiment, the returning portions 79 are formed in the cap 74. However, in a third modification, returning portions 79 are formed at first and second electrodes 81 and 82 as shown in FIGS. 11A and 11B.

In the configuration according to the third modification, instead of the screw holes 68, insertion holes 63 into which retaining members 90 and 94 are inserted are formed at a device housing 62 of a fixing device 60.

Retaining members 90 and 94 are formed at the first and second electrodes 81 and 82. The retaining member 90 includes first and second portions 90A and 90B. The first portion 90A is fixed to the other end portion 83B of the first connection electrode 83 in the longitudinal direction (the end portion of the first connection electrode 83 in the negative X direction). The second portion 90B extends from the end portion of the first portion 90A in the X direction toward the bimetal 76 (the Y direction). A returning portion 79B is formed at a leading end portion of the second portion 90B.

As the retaining member 90, the retaining member 94 includes first and second portions 94A and 94B. The first portion 94A is fixed to the other end portion 84B of the second connection electrode 84 in the longitudinal direction (the end portion of the second connection electrode 84 in the X direction). The second portion 94B extends from the end portion of the first portion 94A in the negative X direction toward the bimetal 76 (the Y direction). A returning portion 79A is formed at a leading end portion of the second portion 94B.

The end portions (base end portions) of the returning portions 79A and 79B in the Y direction are connected to the second portion 94B of the retaining member 94 and the second portion 90B of the retaining member 90, and the returning portions 79A and 79B are inclined to the axial direction of the housing 72 (the Y direction) so as to gradually spread out in the radial direction (the X direction in the case of the returning portion 79A and the negative X direction in the case of the returning portion 79B) toward the end portions (leading end portions) of the returning portions 79A and 79B in the negative Y direction.

The returning portions 79A and 79B are formed of leaf springs of which end portions (leading end portions) in the negative Y direction can be closed to the inside in the radial direction (the negative X direction in the case of the returning portion 79A and the X direction in the case of the returning portion 79B). Accordingly, when the thermostat 70 is inserted into the insertion hole 63 of the fixing device 60 and the returning portions 79A and 79B are inserted into the insertion holes 63, the returning portions 79A and 79B come into contact with the inner walls of the insertion holes 63 and are closed. When reaching the inner side of the wall of the device housing 62, the returning portions 79A and 79B spread out in the radial direction of the housing 72 by the elastic forces thereof.

In this state, the end portions (leading end portions) of the returning portions 79A and 79B in the negative Y direction are caught by the wall of the device housing 62, so that the separation of the thermostat 70 from the insertion hole 62A is regulated.

Moreover, in the above-mentioned this exemplary embodiment, the first and second contacts 91 and 92 are adapted to be separated from each other when the bimetal 76, which is held on the housing 72 so as to be concave from the inside of the housing 72 (in a state shown in FIG. 4A), is displaced (inverted) so as to be convex toward the inside of the housing 72 (to a state shown in FIG. 4B). However, the first and second contacts 91 and 92 may be adapted to be separated from each other when the bimetal 76, which is held on the housing 72 so as to be concave from the outside of the housing 72 (in a state shown in FIG. 4B), is displaced (inverted) so as to be convex toward the outside of the housing 72 (to a state shown in FIG. 4A).

Specifically, for example, first and second contacts 91 and 92 may be adapted as described below. That is, the second electrode 82 (the second contact electrode 86) is urged so that not the first electrode 81 (the first contact electrode 85) but the second contact 92 is separated from the first contact 91 toward the bimetal 76, and the bimetal 76, which is in a concave state (a state shown in FIG. 4B), pushes one end portion 78A of the pin 78 (the end portion of the pin 78 in the Y direction). Accordingly, the other end portion 78B of the pin 78 (the end portion of the pin 78 in the negative Y direction) pushes the second electrode 82 (the second contact electrode 86), so that the first and second contacts 91 and 92 come into contact with each other. Further, the pin 78 is moved toward the bimetal 76 (the Y direction) by an urging force, which acts on the second electrode 82 (the second contact electrode 86) when the bimetal 76 is displaced so as to be convex (to a state shown in FIG. 4A). As a result, the first and second contacts 91 and 92 are separated from each other.

The invention is not limited to the above-mentioned exemplary embodiment, and may have various modifications, alterations, and improvements. For example, plural modifications of the above-mentioned modifications may be appropriately combined with each other.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A thermal switch comprising:
a body that includes a pair of electrodes and is inserted into an insertion hole formed at a mounting portion so as to be mounted on the mounting portion;
a displacement member that is held on the body and displaced according to temperature change;
a synchronization member that is provided at the body and separates one contact of the pair of electrodes from the other contact thereof in synchronism with the displacement of the displacement member; and
regulating portions that are provided at the body and regulate the separation of the body from the insertion hole.

2. The thermal switch according to claim 1,
wherein the body includes a housing, and a holding member that is provided on the housing and holds the displacement member between the housing and the holding member, and
the regulating portions are provided at the holding member, and the holding member is separated from the housing when a predetermined load is applied to the regulating portions.

3. A mounting structure comprising:
a device housing in which a heating element is provided and which is provided with an insertion hole;
a thermal switch that includes a body, a displacement member, and a synchronization member, the body including a pair of electrodes and being inserted into the insertion hole so as to be mounted on the device housing, the displacement member being held on the body and displaced according to temperature change, and the synchronization member being provided at the body and separating one contact of the pair of electrodes from the other contact thereof in synchronism with the displacement of the displacement member; and
regulating portions that are provided at the device housing or the body and regulate the separation of the body from the insertion hole.

4. The mounting structure according to claim 3,
wherein the body includes a housing, and a holding member that is provided on the housing and holds the displacement member between the housing and the holding member, and
the regulating portions are provided at the holding member, and the holding member is separated from the housing when a predetermined load is applied to the regulating portions.

5. A fixing device that fixes an image to a recording medium, the fixing device comprising:
a heating member as the heating element that heats the image formed on the recording medium;
a circuit that supplies power to the heating member; and
the mounting structure according to claim 3 where the pair of electrodes is provided in the circuit, the displacement member is displaced according to temperature change caused by radiant heat from the heating member, and the one contact is separated from the other contact, so that the thermal switch shuts off the circuit.

6. An image forming apparatus comprising:
an image forming section that forms images on a recording medium; and
the fixing device according to claim 5 that fixes the images formed by the image forming section to a recording medium.
